(19) United States
(12) Patent Application Publication
(10) Pub. No.: US 2020/0352111 A1
(43) Pub. Date: Nov. 12, 2020

(54) GARDEN PLANT STAND

(71) Applicant: Donna Williams, Tarboro, NC (US)

(72) Inventor: Donna Williams, Tarboro, NC (US)

(21) Appl. No.: 16/408,962

(22) Filed: May 10, 2019

(51) Int. Cl. A01G 9/12

(52) U.S. Cl. CPC A01G 9/122

(57) ABSTRACT

An apparatus for holding a plant is presented. The apparatus has a top surface and a plurality of legs. The legs are connected to the underside of the top surface. There is a plurality of bars presented to stabilize the table as they are coupled to the legs and provide strength and stability. The bars create a crisscross between the legs. The legs may have a prong-like footing to be secured into the ground to further stabilize the apparatus. The apparatus presents a safe secure place to work on, or to show plants of all kinds.

### FIELD OF THE INVENTION

This invention relates to stands. More particularly, it relates to stands for supporting garden plants.

### BACKGROUND

There is no admission that the background art disclosed in this section legally constitutes prior art.

There have been many attempts at garden stands. Such an example is a raised garden bed and notes that gardens that include a garden bed having a portion raised above ground level are well known in the art of gardening. Gardens with raised garden beds generally include wooden boards. However, a number of problems are associated with the use of wooden boards with raised garden beds. Wooden boards are susceptible to: (i) internal damage such as caused by wood rot and termites; and (ii) splinters.

This example of a raised garden bed also had an aerated bed design that allows for avoidance of conventional methods of aeration, which would otherwise require the labor of turning the soil over or tilling. Further many crops that are grown in gardens require vertical supports for supporting climbing plants. To supply vertical supports, one often provides sticks or twigs which are not easily supported in the soil. Sticks and twigs that are often used to provide vertical supports for climbing plants are often unattractive to look at and present a highly irregular and unsightly visual appearance.

The use of a stake member that maybe driven into the soil bed inside the garden on one end, and on the other end can function as a vertical riser portion that supports a horizontal foliage support member. The stake member does not appear to provide any structural support for the base of the garden bed itself, but rather merely seems to function as a source for vertical growth support. While the garden may be separated and isolated from the ground surface by virtue of the disclosed garden frame, it does not teach a garden elevated on a stand several feet above a ground surface so that gardening access and activities may be accomplished more easily.

Another attempt was a raised garden bed planter box for containing suitable planting soil or other growing media. A U-shaped, fenced in garden enclosure, not a bed elevated on a single stand, let alone an elevated system design to minimize obstruction of, or to maximize access to, the area below the elevated garden. To the contrary, the boxed design and fencing are said to help protect the plants from unwanted pests from eating the plants.

Another attempt was a raised garden bed system including a sprinkler system, and the like. This garden bed system promoted an easily shipped and assembled raised garden system constructed of light weight, environmentally friendly materials. The garden bed system included a trellis system that may function as an attachment location to facilitate for vertical growth within the garden, but does not include an elevated stand, but instead a garden box frame the will sit directly on a flat surface. Moreover, the trellis was not designed to be connected at the upper regions, thus limited the availability of vertical support locations and the strength of the overall trellis system.

### BRIEF DESCRIPTION OF THE DRAWINGS

FIG. 1 is an illustrated exemplary round garden table.

FIG. 2 is an illustrated exemplary square garden table.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

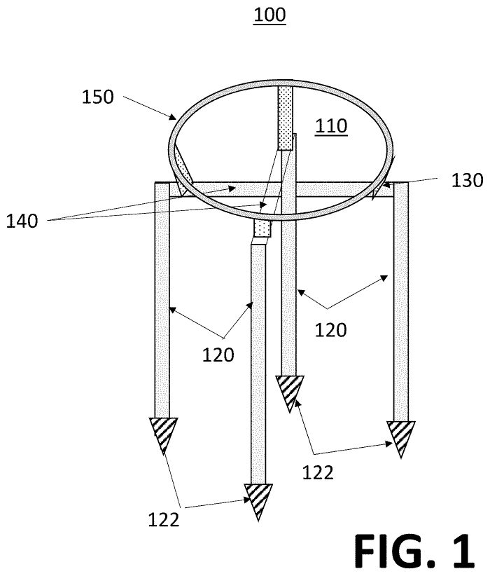

Referring to FIG. 1, an apparatus 100 for holding garden plants is shown. The apparatus 100 is useful to add security and stability to a stand while working on plants on the apparatus 100. This apparatus 100 provides an easy, economically favorable way for a gardener to have more enjoyment and less time cleaning up a mess from an unsecure garden table.

The apparatus 100 may be made of any material such as a durable, lightweight metal material. Further, the apparatus 100 may be protected by painting the apparatus 100, powder coating the apparatus 100, or any other long lasting, non- toxic protection. The apparatus 100 may be hued in any color, green is preferable for gardening, but other colors may be used as the gardener desires.

The apparatus 100 has a top surface 110. The top surface 110 has an underside 130. The top surface 110 is generally flat but may also be concave, etc. The top surface 110 is round, but may be of any shape including oval, rectangular, hexagonal, square, etc. Further, the top surface 110 may have a normal size for garden use, such as round top surface 110 may have a diameter of eight (8) inches, a diameter of twelve and one-half (12.5) inches, or any other diameter that accommodates the needs of the gardener and the weight of heavy pots.

The apparatus 100 has a plurality of legs 120. The plurality of legs 120 may be any length such as for top surface 110 of eight (8) inches, each of the plurality of legs would be preferably ten (10) inches in height, while a twelve and one-half (12.5) inch diameter top surface 110 preferably has a thirteen (13) inch length of legs. One can accommodate other lengths than those being sited.

The plurality of legs 120 may have a spiked end 122. The spiked end 122 allows for the apparatus 100 to be inserted easily into the ground to allow for greater safety and security of the apparatus 100 while working at the apparatus 100.

The plurality of legs 120 are coupled securely to the underside 130 of the top surface 110 of the apparatus. Each of the plurality of legs are preferably spaced evenly apart to increase stability. The plurality of legs 120 is preferably four (4) but may be any number that provides a secure structure to work on gardening.

The apparatus 100 further has a plurality of bars 140. The plurality of bars 140 are generally coupled to the plurality of legs 120 in a crisscross configuration. Thus, a first bar 140 would be coupled to a first and second of the plurality of legs 120 where the first and second legs 120 are opposite of each other. A second bar 140 would be coupled across the first bar 140 and coupled to a third leg 140 and a fourth leg 140.

The plurality of bars 140 is preferably coupled closer to the top surface 110 of the apparatus 100 than the spiked end 122 of the plurality of legs 120. Thus, they provide security while not impeding the pushing the spiked end 122 of the legs 120 into the ground at various depths.

The top surface 110 of the apparatus 100 has a border 150. The border 150 preferably extends above the top surface 110 and is useful to help prevent any thing, including plants to be impeded from failing or sliding off the edge of the top surface 110 of the apparatus 100.

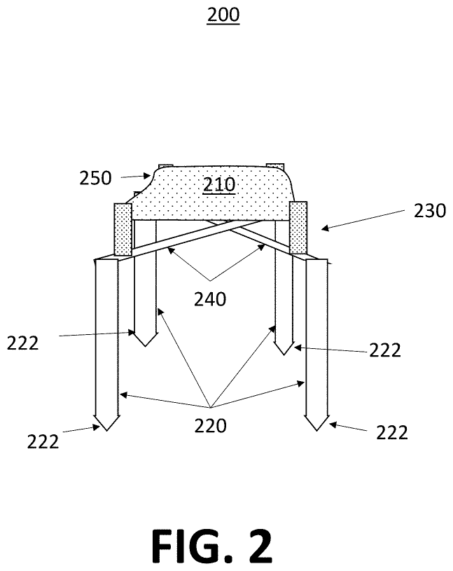

Moving now to FIG. 2, an apparatus 200 for holding garden plants is shown. The apparatus 200 is useful to add security and stability to a stand while working on plants on the apparatus 200. This apparatus 200 provides an easy, economically favorable way for a gardener to have more enjoyment and less time cleaning up a mess from an unsecure garden table.

The apparatus 200 may be made of any material such as a durable, lightweight metal material. Further, the apparatus 200 may be protected by painting the apparatus 200, powder coating the apparatus 200, or any other long lasting, non-toxic protection. The apparatus 200 may be hued in any color, green is preferable for gardening, but other colors may be used as the gardener desires.

The apparatus 200 has a top surface 210. The top surface 210 has an underside 230. The top surface 210 is generally flat but may also be concave, etc. The top surface 210 is square, but may be of any shape including oval, rectangular, hexagonal, round, etc. Further, the top surface 210 may have a normal size for garden use, such as square top surface 210 may have a size of twelve and one-half (12.5) inches by twelve and one-half (12.5) inches, eight (8) inches by eight (8) inches, or any other size that accommodates the needs of the gardener and the weight of pots being used.

The apparatus 200 has a plurality of legs 220. The plurality of legs 220 may be any length such as for top surface 210 of eight (8) inches by eight (8) inches, each of the plurality of legs would be preferably eight (8) inches in height, while a twelve and one-half inch by twelve and one-half inch (12.5″×12.5″) square top surface 210 preferably has twelve and one-half (12.5) inch legs. One can accommodate other lengths than those being sited.

The plurality of legs 220 may have a spiked end 222. The spiked end 222 allows for the apparatus 200 to be inserted easily into the ground to allow for greater safety and security of the apparatus 200 while working at the apparatus 200.

The plurality of legs 220 are coupled securely to the underside 230 of the top surface 210 of the apparatus. Each of the plurality of legs 220 are preferably spaced evenly apart to increase stability. The plurality of legs 220 is preferably four (4) but may be any number that provides a secure structure to work on gardening.

The apparatus 200 further has a plurality of bars 240. The plurality of bars 240 are generally coupled to the plurality of legs 220 in a crisscross configuration. Thus, a first bar 240 would be coupled to a first and second of the plurality of legs 220 where the first and second legs 220 are opposite of each other. A second bar 240 would be coupled across the first bar 240 and coupled to a third leg 240 and a fourth leg 240.

The plurality of bars 240 is preferably coupled closer to the top surface 210 of the apparatus 200 than the spiked end 222 of the plurality of legs 220. Thus, they provide security while not impeding the pushing the spiked end 222 of the legs 220 into the ground at various depths.

The top surface 210 of the apparatus 200 has a border 250. The border 250 preferably extends above the top surface 210 and is useful to help prevent any thing, including plants to be impeded from failing or sliding off the edge of the top surface 210 of the apparatus 200.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An apparatus for holding a plant, comprising:
a top surface;
a plurality of legs, said plurality of legs being connected to an underside of said top surface;
a plurality of bars, said plurality of bars connected to said plurality of legs and said plurality of bars making a crisscross configuration; and
a border, said border extending about a periphery of said top surface and configured to prevent said plant from falling off said apparatus.

2. The apparatus of claim 1, wherein said top surface is a flat surface.

3. The apparatus of claim 1, wherein said plurality of legs comprises 4 legs.

4. The apparatus of claim 1, wherein each of said plurality of legs has a spiked end.

5. The apparatus of claim 1, wherein one of said plurality of bars extends from one of said plurality of legs to a second of said plurality of legs.

6. The apparatus of claim 1, wherein a second of said plurality of bars extends from a third of said plurality of legs to a fourth of said plurality of legs.

7. The apparatus of claim 1, wherein said top surface is circular in shape.

8. The apparatus of claim 1, wherein said top surface is square in shape.

9. The apparatus of claim 1, wherein said plurality of bars is located below said top surface.

10. The apparatus of claim 8, wherein said square shape is 8 inches by 8 inches.

11. The apparatus of claim 8, wherein said square shape is 12.5 inches by 12.5 inches.

12. The apparatus of claim 7, wherein said circular shape has a diameter of 8 inches.

13. The apparatus of claim 7, wherein said circular shape has a diameter of 12.5 inches.

14. The apparatus of claim 1, wherein said apparatus is made of a durable, lightweight metal material.

15. The apparatus of claim 1, wherein said apparatus is powder-coated.

16. The apparatus of claim 1, wherein said apparatus is painted.

17. The apparatus of claim 1, wherein each of the legs being ten (10) inches in length.
